(19) United States
(12) Patent Application Publication
(10) Pub. No.: US 2025/0048356 A1
(43) Pub. Date: Feb. 6, 2025

(54) TERMINAL, BASE STATION, RADIO COMMUNICATION SYSTEM AND RADIO COMMUNICATION METHOD

(71) Applicant: NTT DOCOMO, INC., Tokyo (JP)

(72) Inventors: Shohei YOSHIOKA, Tokyo (JP); Yuki MATSUMURA, Tokyo (JP); Satoshi NAGATA, Tokyo (JP)

(73) Assignee: NTT DOCOMO, INC., Tokyo (JP)

(21) Appl. No.: 18/717,483

(22) PCT Filed: Dec. 10, 2021
(86) PCT No.: PCT/JP2021/045712

§ 371 Date: Jun. 7, 2024

(51) Int. Cl. H04W 72/1268

(52) U.S. Cl. CPC H04W 72/1268

(57) ABSTRACT

A terminal includes: a transmission unit that transmits feedback of an automatic repeat request; and a control unit assuming that when a bit string of the feedback and a resource of an uplink control channel are associated with each other and only a negative acknowledgment is fed back, an index of the resource indicates a correspondence relationship between a bit string of the feedback and the resource, in which an upper limit on the number of multiplexed bits of the feedback is configured by an upper layer parameter.

### TECHNICAL FIELD

The present disclosure relates to a terminal, a base station, a radio communication system, and a radio communication method that support multicast and broadcast services.

### BACKGROUND ART

The 3rd Generation Partnership Project (3GPP) has prepared a specification for the 5th generation mobile communication system (which may be called 5G, New Radio (NR), or Next Generation (NG)), and is also in the process of specifying the next generation called Beyond 5G, 5G Evolution, or 6G.

In 3GPP Release-17, simultaneous data transmission (also called distribution) services (which is called MBS: Multicast and Broadcast Services (tentative name)) with respect to multiple specified or unspecified terminals (User Equipment, UE) in NR have been targeted (NON-PATENT LITERATURE 1).

In MBS, for example, the scheduling of UE groups that is a target for the services and the improvement of reliability (for example, feedback of Hybrid Automatic repeat request (HARQ) to radio base station (gNB)) have been studied.

### CITATION LIST

### Non-Patent Literature

NON-PATENT LITERATURE 1: “New Work Item on NR support of Multicast and Broadcast Services”, RP-193248, 3GPP TSG RAN Meeting #86, 3GPP, December 2019

### SUMMARY OF THE INVENTION

Even in an HARQ of MBS, it is assumed to apply a scheme that feeds back only a NACK (NACK-only feedback).

However, in the case of MBS, since the configuration (multiplexing) method of NACK-only feedback can be different for each UE, there is a problem that the network (gNB) cannot recognize the number of bits of feedback, thereby requiring blind decoding (BD).

Therefore, the following disclosure has been made in view of such circumstances, and an object of the present disclosure is to provide a terminal, a base station, a radio communication system and a radio communication method with which it is possible to realize efficient NACK-only feedback in MBS.

An aspect of the present disclosure is a terminal including: a transmission unit that transmits feedback of an automatic repeat request; and a control unit assuming that when a bit string of the feedback and a resource of an uplink control channel are associated with each other and only a negative acknowledgment is fed back, an index of the resource indicates a correspondence relationship between a bit string of the feedback and the resource, in which an upper limit on the number of multiplexed bits of the feedback is configured by an upper layer parameter.

An aspect of the present disclosure is a base station including: a reception unit that receives feedback of an automatic repeat request; and a control unit assuming that when a bit string of the feedback and a resource of an uplink control channel are associated with each other and only a negative acknowledgment is fed back, an index of the resource indicates a correspondence relationship between a bit string of the feedback and the resource, in which an upper limit on the number of multiplexed bits of the feedback is configured by an upper layer parameter.

An aspect of the present disclosure is a radio communication system including a terminal and a base station, in which the terminal includes: a transmission unit that transmits feedback of an automatic repeat request; and a control unit assuming that when a bit string of the feedback and a resource of an uplink control channel are associated with each other and only a negative acknowledgment is fed back, an index of the resource indicates a correspondence relationship between a bit string of the feedback and the resource, and an upper limit on the number of multiplexed bits of the feedback is configured by an upper layer parameter.

An aspect of the present disclosure is a radio communication method including: a step of transmitting feedback of an automatic repeat request; and a step of assuming that when a bit string of the feedback and a resource of an uplink control channel are associated with each other and only a negative acknowledgment is fed back, an index of the resource indicates a correspondence relationship between a bit string of the feedback and the resource, in which an upper limit on the number of multiplexed bits of the feedback is configured by an upper layer parameter.

### BRIEF DESCRIPTION OF THE DRAWINGS

FIG. 1 is an overall schematic diagram of a radio communication system 10.

FIG. 2 is a diagram illustrating a configuration example of radio frames, subframes, and slots used in the radio communication system 10.

FIG. 3 is a diagram illustrating a configuration example of PTM transmission scheme 1 and PTM transmission scheme 2.

FIG. 4 is a functional block diagram of a gNB 100 and UE 200.

FIG. 5 is a diagram illustrating a sequence example of a PDCCH, a PDSCH and HARQ feedback in MBS.

FIG. 6 is a diagram illustrating a determination example of a PUCCH resource according to Scheme A.

FIG. 7 is a diagram illustrating a transmission example of sequence-based uplink control information (UCI) applicable to PUCCH format 0 (PF 0).

FIG. 8 is a diagram illustrating an allocation example of an HARQ-ACK and a scheduling request (Positive SR and Negative SR).

FIG. 9 is a diagram illustrating an example of a signal point of BPSK according to operation example 2-2b.

FIG. 10 is a diagram illustrating a configuration example of a PUCCH resource set according to operation example 3-1 and of a table linked with the PUCCH resource set.

FIG. 11 is a diagram illustrating a configuration example (part 1) of a PUCCH resource set according to operation example 3-2 and of a table linked with the PUCCH resource set.

FIG. 12 is a diagram illustrating a configuration example (part 2) of a PUCCH resource set according to the operation example 3-2 and of a table linked with the PUCCH resource set.

FIG. 13 is a diagram illustrating a determination example of NACK-only feedback according to operation example 3-4 and of PUCCH resource set according to ACK/NACK feedback.

FIG. 14 illustrates an example of a PUCCH resource set according to operation example 3-6.

FIG. 15 is a diagram illustrating an example of signal points on an IQ plane according to operation example 5-1.

FIG. 16 is a diagram illustrating a configuration example of a PUCCH resource set according to the operation example 5-1 and of a table linked with the PUCCH resource set.

FIG. 17 is a diagram illustrating an example of a hardware configuration of the gNB 100 and the UE 200.

FIG. 18 is a diagram illustrating a configuration example of a vehicle 2001.

### DESCRIPTION OF EMBODIMENTS

Embodiments will be described below with reference to the drawings. Note that the same or similar reference numerals have been attached to the same functions and configurations, and the description thereof will be omitted as appropriate.

### (1) Overall Schematic Configuration of Radio Communication System

### (1.1) System Configuration Example

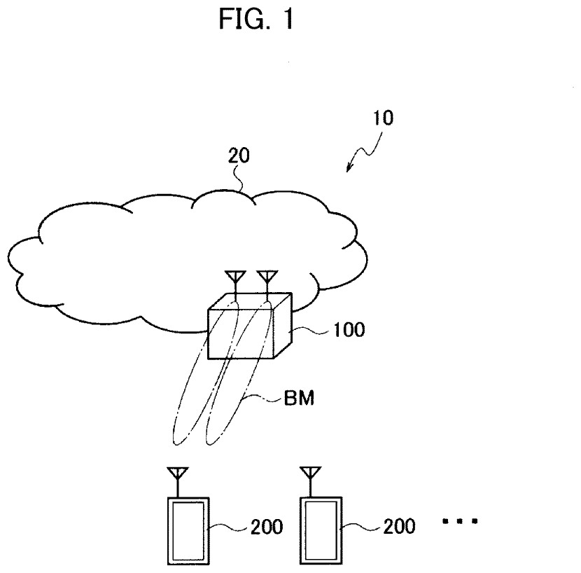

FIG. 1 is an overall schematic diagram of a radio communication system 10 according to the present embodiment. The radio communication system 10 is a radio communication system according to 5G New Radio (NR), and includes a Next Generation-Radio Access Network 20 (hereinafter, NG-RAN 20) and a plurality of terminals 200 (User Equipment 200, hereinafter, UE 200).

The radio communication system 10 may be a radio communication system according to a scheme called Beyond 5G, 5G Evolution, or 6G.

The NG-RAN 20 includes radio base stations 100 (gNB 100). The specific configuration of the radio communication system 10 including the number of gNBs and UEs is not limited to the example illustrated in FIG. 1.

The NG-RAN 20 actually includes a plurality of NG-RAN nodes, specifically gNBs (or ng-eNBs), and is connected to a core network (5GC, not illustrated) according to 5G. The NG-RAN 20 and 5GC may be referred to simply as a network.

The gNB 100 is a radio base station according to NR, and performs radio communication with the UE 200 according to NR. By controlling radio signals transmitted from a plurality of antenna elements, the gNB 100 and the UE 200 can support Massive MIMO that generates a more directional beam BM, carrier aggregation (CA) that uses a plurality of component carriers (CCs) bundled together, dual connectivity (DC) that simultaneously performs communication between the UE and each of NG-RAN nodes, and the like.

The radio communication system 10 supports FR1 and FR2. The frequency band of each FR (frequency range) is as follows:
FR1: 410 MHz to 7.125 GHZ
FR2: 24.25 MHz to 52.6 GHz

In FR1, Sub-Carrier Spacing (SCS) of 15, 30 or 60 KHz may be used and a bandwidth (BW) of 5 to 100 MHz may be used. FR2 has a higher frequency than FR1, and SCS of 60 or 120 kHz (may include 240 kHz) may be used and a bandwidth (BW) of 50 to 400 MHz may be used.

In addition, the radio communication system 10 may support a higher frequency band than that of FR2. Specifically, the radio communication system 10 may support a frequency band that is greater than 52.6 GHZ and up to 114.25 GHz. The radio communication system 10 may support a frequency band between FR1 and FR2.

Further, Cyclic Prefix-Orthogonal Frequency Division Multiplexing (CP-OFDM)/Discrete Fourier Transform-Spread (DFT-S-OFDM) having greater Sub-Carrier Spacing (SCS) may be applied. Furthermore, DFT-S-OFDM may be applied not only to the uplink (UL), but also to the downlink (DL).

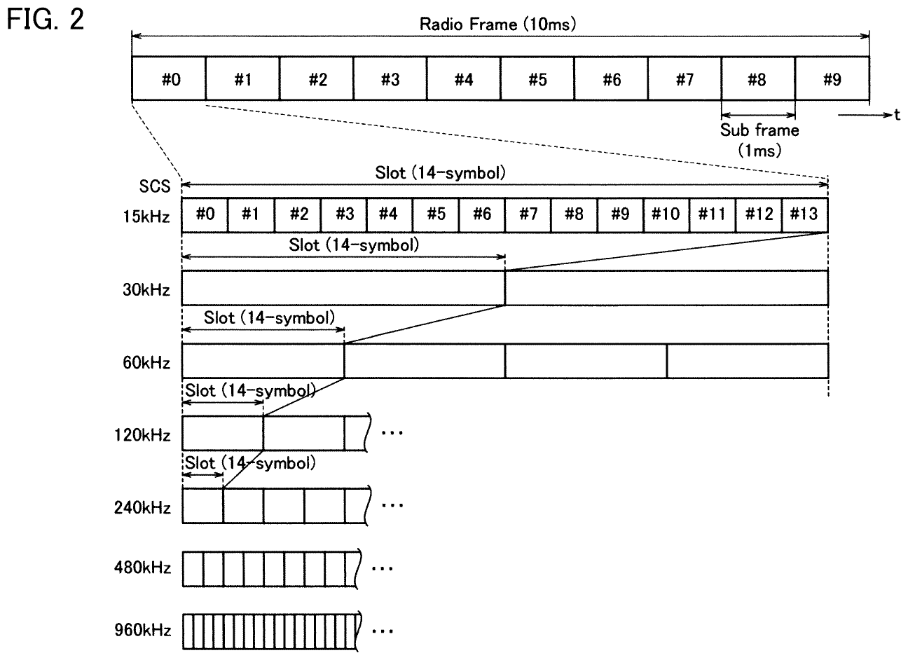

FIG. 2 illustrates a configuration example of radio frames, subframes and slots used in the radio communication system 10.

As illustrated in FIG. 2, one slot is constituted of 14 symbols, and, the symbol period (and slot period) becomes shorter as the SCS becomes larger (wider). Note that the number of symbols constituting one slot may not necessarily be 14 symbols (for example, 28 or 56 symbols). The number of slots for each subframe may vary depending on the SCS. In addition, the SCS may be wider than 240 kHz (for example, as illustrated in FIG. 2, 480 kHz, and 960 kHz).

Note that the time direction (t) illustrated in FIG. 2 may be referred to as a time domain, a symbol period, symbol time, or the like. The frequency direction may be referred to as a frequency domain, a resource block, a resource block group, a subcarrier, a Bandwidth part (BWP), a subchannel, a common frequency resource, or the like.

### (1.2) Provision of MBS

Multicast and Broadcast Services (MBS) may be provided in the radio communication system 10.

For example, in a stadium or hall, it is assumed that a large number of UEs 200 are located in a certain geographic area and a large number of UEs 200 simultaneously receive the same data. In such a case, the use of MBS rather than unicast is effective.

Unicast may be interpreted as communication performed one-to-one with the network by specifying a specific UE 200 (identification information specific to UE 200 may be specified).

Multicast may be interpreted as communication performed one-to-plural numbers (specified numbers) with the network by specifying a specific plurality of UEs 200 (identification information for multicast may be specified). Note that the number of UEs 200 that receive the received multicast data may be one.

The broadcast may be interpreted as communication performed one-to-unspecified numbers with the network for all UEs 200. The data subjected to multicast/broadcast may have the same copied content, but some content, such as a header, may be different. Also, the data subjected to multicast/broadcast may be transmitted (distributed) simultaneously, but does not necessarily require strict concurrency, and may include propagation delays and/or processing delays in the RAN nodes, and the like.

In target UE 200, a radio resource control layer (RRC) may be in an idle state (RRC idle), a connected state (RRC connected), or any other state (for example, inactive state). The inactive state may be interpreted as a state in which some configuration of RRC are maintained.

In MBS, the following three methods are assumed for scheduling of multicast/broadcast PDSCH (Physical Downlink Shared Channel), specifically, scheduling of MBS packets (which may be read as meaning data). RRC connected UE may be read as meaning RRC idle UE or RRC inactive UE.
PTM transmission scheme 1 (PTM-1):
   A group-common PDSCH is scheduled using a group-common PDCCH (Physical Downlink Control Channel) for a MBS group of RRC connected UE.
   CRC of PDCCH and PDSCH are scrambled by a group-common Radio Network Temporary Identifier (which may be referred to as a G-RNTI).
PTM transmission scheme 2 (PTM-2):
   A group-common PDSCH is scheduled using a terminal specific (UE-specific) PDCCH for a MBS group of RRC connected UE.
   CRC of PDCCH is scrambled by a UE-specific RNTI.
   PDSCH is scrambled by a group-common RNTI.
PTP transmission scheme:
   A UE-specific PDSCH is scheduled using a UE-specific PDCCH for RRC connected UE.
   CRC of PDCCH and PDSCH are scrambled by a UE-specific RNTI. That is, it may mean that MBS packets are transmitted by unicast.

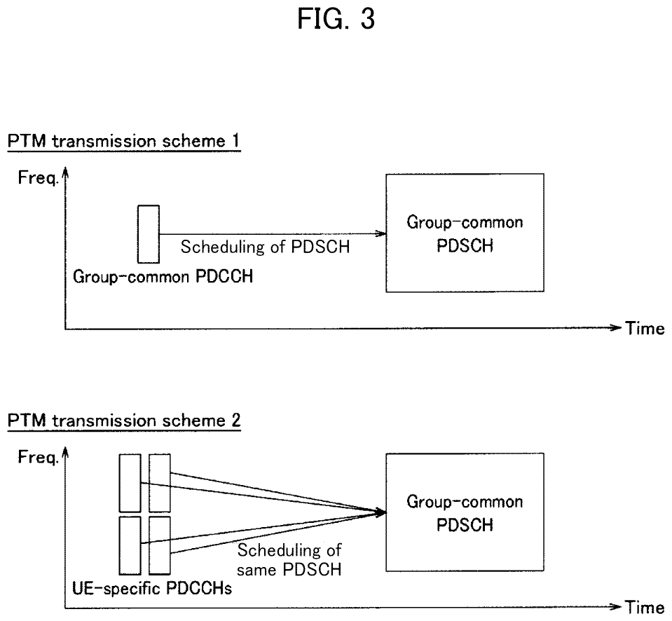

FIG. 3 illustrates a configuration example of the PTM transmission scheme 1 and the PTM transmission scheme 2. The UE-specific PDCCH/PDSCH may be identified by a target UE, but may not be identified by other UEs in the same MBS group. The group-common PDCCH/PDSCH is transmitted at the same time/frequency resource and can be identified by all UEs in the same MBS group. Further, the names of the PTM transmission schemes 1 and 2 are tentative and may be called by different names as long as the operations described above are performed.

In point-to-point (PTP) distribution, the RAN node may wirelessly distribute individual copies of MBS data packets to individual UEs. In point-to-multipoint (PTM) distribution, the RAN node may wirelessly distribute a single copy of MBS data packets to a set of UEs.

In order to improve the MBS reliability, the following two feedback methods are assumed for HARQ (Hybrid Automatic repeat request) feedback, specifically, HARQ feedback for multicast/broadcast PDSCH.
Option 1: Feedback of both ACK and NACK (ACK/NACK feedback).
   UE that has successfully received/decoded a PDSCH transmits an ACK.
   UE that has failed to receive/decode a PDSCH transmits a NACK.
   PUCCH (Physical Uplink Control Channel) resource configuration: PUCCH-Config can be configured for multicast.
   PUCCH resource: shared/orthogonal between UEs depends on network configuration.
   HARQ-ACK CB (codebook): type-1 and type-2 (CB decision algorithm (specified in 3GPP TS 38.213)) are supported.
   Multiplexing: unicast or multicast can be applied
   Option 2: NACK-only feedback.
   UE that has successfully received/decoded a PDSCH does not transmit an ACK (does not transmit a response).
   UE that has failed to receive/decode a PDSCH transmits a NACK.
   For given UE, PUCCH resource configuration can be configured separately by unicast or group cast (multicast).

Note that an ACK may be called a positive acknowledgment and a NACK may be called a negative acknowledgment. An HARQ may be called an automatic resend request.

Any of the following can be applied to enable/disable option 1 or option 2.
RRC and Downlink Control Information (DCI)
RRC only

In addition, the following content is assumed for Semi-persistent Scheduling (SPS) for multicast/broadcast PDSCH:
A SPS group-common PDSCH (which may be called a group common SPS PDSCH) is adopted.
Multiple SPS group-common PDSCHs can be configured as UE capabilities.
HARQ feedback for SPS group-common PDSCH is possible.
At least activation/deactivation via a group-common PDCCH (downlink control channel) is possible.

Note that deactivation may be read as meaning other synonymous terms such as release. For example, activation may be read as meaning boot, start, trigger, or the like, and deactivation may be read as meaning end, stop, or the like.

SPS is scheduling used in contrast to dynamic scheduling, and may be referred to as semi-fixed, semi-persistent, or semi-persistent scheduling, and may be interpreted as Configured Scheduling (CS).

Scheduling may be interpreted as the process of allocating resources for transmitting data. Dynamic scheduling may be interpreted as a mechanism by which all PDSCHs are scheduled by DCI (for example, DCI format 1_0, DCI format 1_1). SPS may be interpreted as a mechanism by which PDSCH transmissions are scheduled by signaling in a higher layer, such as RRC messages.

Note that Multicast SPS PDSCH reception may refer to group common SPS PDSCH reception, or may be SPS PDSCH received by a plurality of terminals, or may be SPS PDSCH reception associated with a G-RNTI or a G-CS-RNTI (that is, a RNTI associated with a plurality of terminals). Multicast may also be read as meaning Broadcast.

For the physical layer, there may be scheduling categories having time domain scheduling and frequency domain scheduling.

Also, multicast, group cast, broadcast, and MBS may be interchangeably interpreted. Multicast PDSCH, and PDSCH that is scrambled by a group common RNTI may be interchangeably interpreted.

Further, the terms such as data and packet may be interchangeably interpreted, and may be interpreted as being synonymous with terms such as signal, data unit. In addition, transmission, reception, and distribution may be interchangeably interpreted.

### (2) Functional Block Configuration of Radio Communication System

Next, a functional block configuration of the radio communication system 10 will be described. Specifically, the functional block configuration of the gNB 100 and the UE 200 will be described.

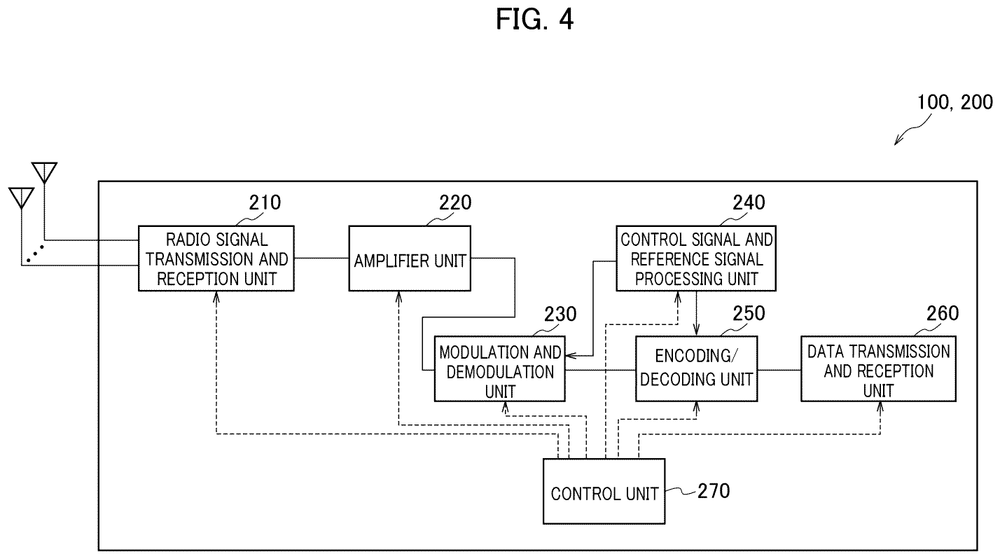

FIG. 4 is a functional block diagram of the gNB 100 and the UE 200. The UE 200 will be described below. As illustrated in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

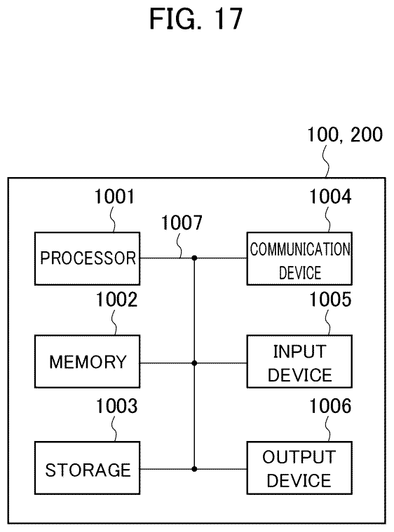

Note that in FIG. 4, only the main functional blocks regarding the description of the embodiment are illustrated, and the UE 200 includes other functional blocks (for example, a power supply unit). FIG. 4 also illustrates a functional block configuration of the UE 200 (gNB 100), and please refer to FIG. 17 for the hardware configuration.

The radio signal transmission and reception unit 210 transmits/receives a radio signal according to NR. The radio signal transmission and reception unit 210 supports Massive MIMO, CA that uses a plurality of CCs bundled together, and DC that simultaneously performs communication between the UE and each of two NG-RAN nodes.

The radio signal transmission and reception unit 210 supports an MBS, and can receive a downlink channel that is common to a group of terminals (group common) in data distribution for a plurality of UEs 200.

In addition, the radio signal transmission and reception unit 210 can receive a downlink data channel (PDSCH) in MBS, that is, in data distribution for a plurality of terminals.

Specifically, the radio signal transmission and reception unit 210 can receive a group-common PDSCH (which may include an SPS group-common PDSCH) which is a downlink data channel (PDSCH) common to a group of terminals.

Further, the radio signal transmission and reception unit 210 can receive a downlink control channel that is common to a group of terminals, specifically, a group-common PDCCH, and can receive a downlink control channel specific to a terminal, specifically, a UE-specific PDCCH.

The amplifier unit 220 is configured by a PA (Power Amplifier)/LNA (Low Noise Amplifier) and the like. The amplifier unit 220 amplifies a signal output from the modulation and demodulation unit 230 to a predetermined power level. The amplifier unit 220 also amplifies an RF signal output from the radio signal transmission and reception unit 210.

The modulation and demodulation unit 230 performs data modulation and demodulation, transmission power configuration, resource block allocation, and the like for each predetermined communication destination (gNB 100 or the like). Cyclic Prefix-Orthogonal Frequency Division Multiplexing (CP-OFDM)/Discrete Fourier Transform-Spread (DFT-S-OFDM) may be applied to the modulation and demodulation unit 230. In addition, DFT-S-OFDM may be used not only for an uplink (UL), but also for a downlink (DL).

The control signal and reference signal processing unit 240 performs processing regarding various control signals transmitted and received by the UE 200, and processing regarding various reference signals transmitted and received by the UE 200.

Specifically, the control signal and reference signal processing unit 240 receives various control signals transmitted from the gNB 100 via a predetermined control channel, for example, the control signals (messages) for the radio resource control layer (RRC). The control signal and reference signal processing unit 240 also transmits various control signals to the gNB 100 via a predetermined control channel.

The control signal and reference signal processing unit 240 performs processing using a reference signal (RS), such as a Demodulation Reference Signal (DMRS) and a Phase Tracking Reference Signal (PTRS).

The DMRS is a known reference signal (pilot signal) between a terminal-specific base station and a terminal for estimating a fading channel used for data demodulation. The PTRS is a terminal-specific reference signal for estimating phase noise, which becomes a problem in high frequency bands.

In addition to the DMRS and PTRS, a reference signal may include a Channel State Information-Reference Signal (CSI-RS), a Sounding Reference Signal (SRS), a Positioning Reference Signal (PRS) for position information, and the like.

The channel includes a control channel and a data channel. The control channel may include a PDCCH, a PUCCH (Physical Uplink Control Channel), a RACH (Random Access Channel, Downlink Control Information (DCI) including a Random Access Radio Network Temporary Identifier (RA-RNTI)), a Physical Broadcast Channel (PBCH), and the like.

In addition, the data channel may include a PDSCH, a PUSCH (Physical Uplink Shared Channel), and the like. “Data” may refer to data transmitted via the data channel.

In the present embodiment, the control signal and reference signal processing unit 240 may constitute a reception unit that receives downlink control information (DCI). In addition, the control signal and reference signal processing unit 240 may receive, in RRC, a message indicating for enabling or disabling a function for which enabling or disabling an HARQ feedback is specified by DCI.

The encoding/decoding unit 250 performs data division/concatenation and channel encoding/decoding for each predetermined destination (gNB 100 or other gNBs).

Specifically, the encoding/decoding unit 250 divides the data output from the data transmission and reception unit 260 into pieces of a predetermined size, and performs channel encoding on the divided data. Further, the encoding/decoding unit 250 decodes the data output from the modulation and demodulation unit 230, and concatenates the decoded data.

The data transmission and reception unit 260 performs transmission and reception of a Protocol Data Unit (PDU) and a Service Data Unit (SDU). Specifically, the data transmission and reception unit 260 performs assembly/disassembly of the PDU/SDU in a plurality of layers (a media access control layer (MAC), a radio link control layer (RLC), a packet data convergence protocol layer (PDCP), or the like).

The data transmission and reception unit 260 also performs error correction and retransmission control of the data, based on a hybrid automatic repeat request (hybrid ARQ). Specifically, the data transmission and reception unit 260 can transmit feedback of the automatic repeat request (HARQ). In the present embodiment, the data transmission and reception unit 260 may constitute a transmission unit.

The HARQ feedback may include an ACK (acknowledgment response) and a NACK (negative response) as described above, and a scheme may be applied in which only a NACK is fed back and no ACK is fed back (NACK-only feedback).

The control unit 270 controls each functional block constituting the UE 200. In particular, in the present embodiment, the control unit 270 performs control on scheduling of a downlink channel regarding MBS, and HARQ feedback of the downlink channel.

The control unit 270 performs, in MBS, that is, in data distribution for the plurality of UEs 200, control corresponding to the scheduling of a downlink channel common to a group of terminals (group common). Specifically, the control unit 270 can perform control corresponding to the scheduling of a group-common PDCCH and a group-common PDSCH.

Regarding the SPS group-common PDSCH, the control unit 270 may assume in units of a group of terminals that SPS of the downlink data channel (PDSCH) for the group of terminals, that is, an activation/deactivation of semi-fixed scheduling is applied.

In addition, when NACK-only feedback is applied, that is, when only a NACK (negative response) of the HARQ is fed back, the control unit 270 may apply only an index of one cyclic shift (CS) (cyclic shift index) to one resource of the PUCCH (uplink control channel).

The application of such a cyclic shift index may be limited to a case where a bit string of the HARQ feedback (which may be called a codebook) and a resource of the PUCCH are associated with each other (which may be called Scheme A). Alternatively, it may be represented as a case where NACK-only feedback is performed using a PUCCH format (PF) 0 in Scheme A. Note that a bit string of the HARQ feedback may be a bit string including an ACK, and may be replaced with a bit string corresponding to PDSCH reception.

PF 0 is called a short format, and the number of symbols may be one or two. Further, such a cyclic shift index may be applied to either the case of transmitting one bit of feedback or the case of transmitting multiple bits in multiplex.

Further, as described above, the control unit 270 may apply Binary Phase Shift Keying (BPSK) to one resource of the PUCCH when a bit string of feedback and a resource of the PUCCH are associated with each other and only a NACK is fed back. In this case, only the BPSK is used, and other phase shift modulations, specifically, quadrature phase shift keying (QPSK) may not be used.

Alternatively, as described above, the control unit 270 may assume that when a bit string of the feedback and a resource of the PUCCH are associated with each other and only a NACK is fed back, an index of the PUCCH resource indicates a correspondence relationship between a bit string of the HARQ feedback and the PUCCH resource.

Specifically, the control unit 270 may assume that a value of the PUCCH resource index is associated with a specific table, and a bit string of the HARQ-ACK and the PUCCH resource are associated with each other in the table. A configuration example of the table will be described later.

In such a case, an upper limit on the number of multiplexed bits of the HARQ-ACK feedback (NACK-only bits using Scheme A) may be configured by an upper layer parameter. The upper layer parameter may be read as meaning an RRC parameter or as meaning RRC signaling.

In addition, the control unit 270 may assume that there is only one set of PUCCH resources when a bit string of the HARQ feedback is bundled and only a NACK is fed back. When a bit string of the HARQ feedback is bundled, it may be referred to as Scheme C for the sake of convenience. In Scheme C, a bit string of the HARQ feedback may be bundled and aggregated into one bit. Specifically, in Scheme C, if there is at least one NACK in one or more bit strings of the HARQ feedback, one bit that is a NACK may be transmitted. Scheme B may mean the HARQ feedback without any processing such as multiplexing (Schemes A-C will be further described later).

In addition, the control unit 270 may apply a plurality of cyclic shift indexes to one resource of the PUCCH when multiplexing multiple bits in NACK-only feedback using a specific PUCCH format.

Specifically, regarding NACK-only feedback using PUCCH format 0 (PF 0), the control unit 270 may use a plurality of cyclic shift indexes per one PUCCH resource when multiplexing multiple bits.

For example, a plurality of cyclic shift indexes may be linked with a specific PUCCH resource, and which cyclic shift index to use may be determined by the success or failure of PDSCH decoding. Alternatively, some of the multiple bits may be represented by selecting a cyclic shift index, and the others may be represented by the PUCCH resource. A specific example of such an operation will be described later.

In addition, the gNB 100 can perform the scheduling of the downlink channel described above, HARQ control, and the like.

### (3) Operation of Radio Communication System

Next, an operation of the radio communication system 10 will be described. Specifically, the operation regarding the scheduling of a downlink channel regarding MBS, and HARQ feedback of the downlink channel will be described.

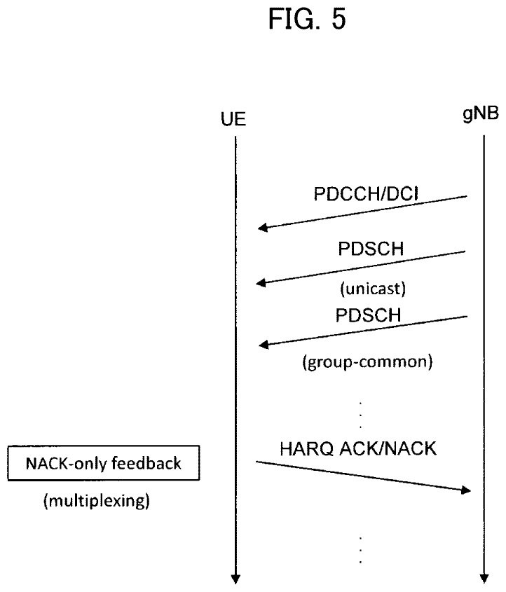

FIG. 5 illustrates a sequence example of a PDCCH, a PDSCH and HARQ feedback in MBS. As illustrated in FIG. 5, a PDCCH (which may include DCI) and a PDSCH may be transmitted by unicast or multicast (broadcast). The UE 200 may also transmit HARQ feedback (ACK/NACK) for (a transport block (TB) that is received via) the channel.

In FIG. 5, it appears that after one PDCCH/DCI, both unicast PDSCH and multicast PDSCH are transmitted; however, after one PDCCH/DCI, either unicast PDSCH or multicast PDSCH may be transmitted. That is, one PDCCH/DCI may schedule either one of unicast PDSCH and multicast PDSCH.

Further, as illustrated in FIG. 5, in the HARQ feedback, NACK-only feedback may be applied as described above, and the feedback information (which may be a bit string) may be multiplexed in the NACK-only feedback.

In the case of MBS, if the function of NACK-only feedback is applied as it is, there is a problem that the gNB 100 cannot recognize the number of bits relating to NACK-only feedback and thus blind decoding is required.

Therefore, the following multiplexing methods may be assumed regarding NACK-only feedback.
(Scheme A): A value of HARQ-ACK codebook (bit string) and a PUCCH resource are linked with each other.
(Scheme B): No multiplexing
(Scheme C): Apply bundling to provide one bit.
(Scheme D): Change feedback by means of NACK-only feedback scheme to feedback by means of ACK/NACK feedback scheme to multiplex and transmit bits.

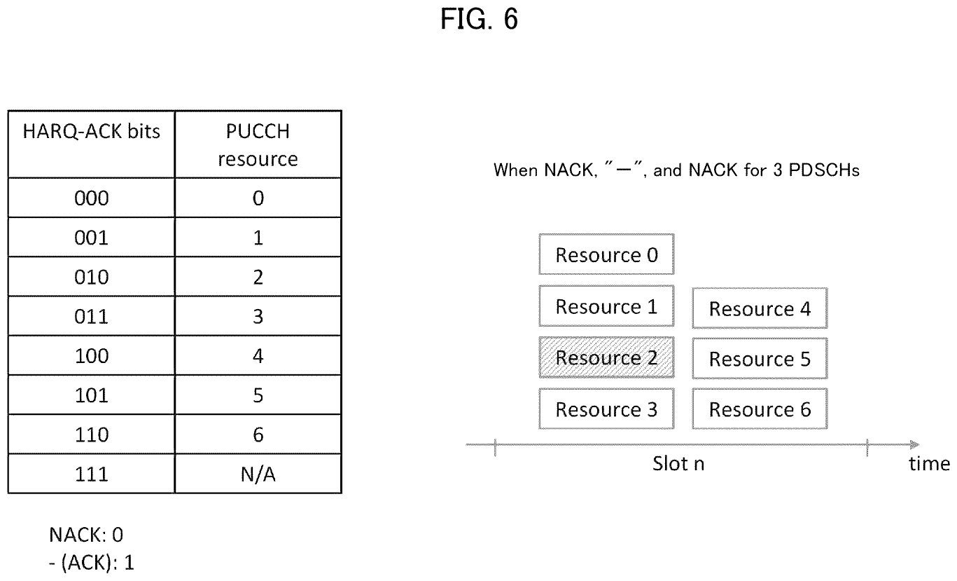

Note that the multiplexing method need not be limited to Schemes A to D. FIG. 6 illustrates a determination example of a PUCCH resource according to Scheme A. As illustrated in FIG. 6, the values of the HARQ codebook (bit string) are associated with the PUCCH resources (which may be a combination of the time direction and the frequency direction).

For example, when the feedback of HARQ for three PDSCH receptions is NACK, -, NACK (010), Resource 2 is used. In Scheme C, as described above, feedback may be transmitted if there is a NACK. Note that “-” may mean that the corresponding PDSCH has been successfully decoded.

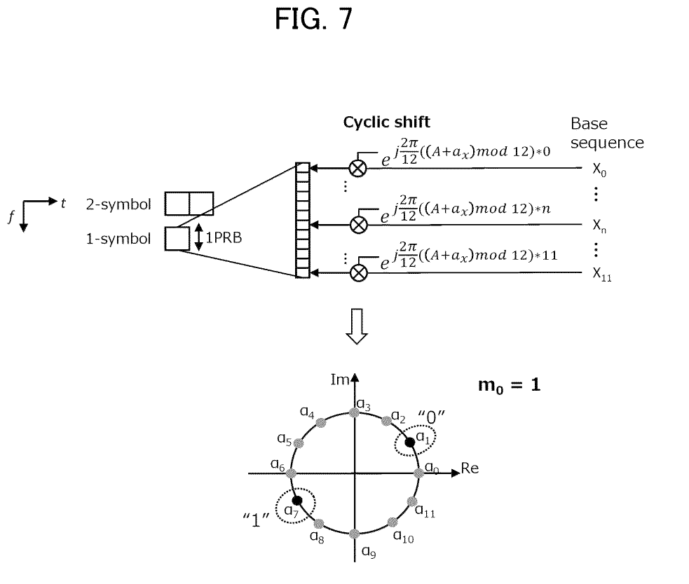

FIG. 7 illustrates a transmission example of sequence-based uplink control information (UCI) applicable to PUCCH format 0 (PF 0). As illustrated in FIG. 7, a cyclic shift is applied to each of the base sequences (X₀, . . . . Xₙ, . . . , X₁₁). The initial cyclic shift m₀ may be configured by an RRC. In FIG. 7, an example of m₀=1 is illustrated. A in FIG. 7 may include m₀. In addition, FIG. 7 illustrates ACK/NACK feedback, and the cyclic shift is determined based on the decoding result of the corresponding PDSCH.

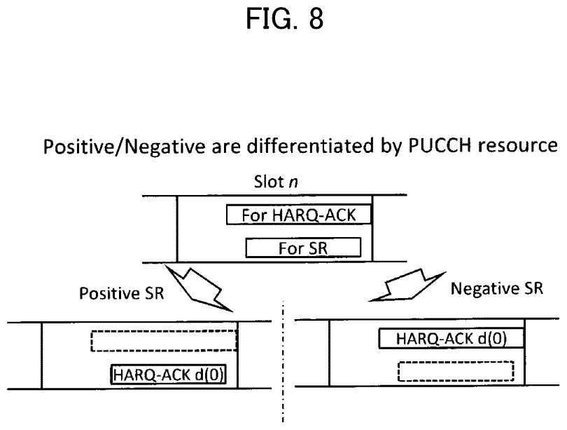

FIG. 8 illustrates an allocation example of an HARQ-ACK and a scheduling request (Positive SR, Negative SR). As illustrated in FIG. 8, the UCI may include scheduling requests (Positive SR, Negative SR) in addition to HARQ feedback, and the PUCCH resources to be used may vary depending on whether they are positive or negative.

### (3.1) Operation Example 1

In this operation example, in Scheme A described above, only one cyclic shift index may be used per one PUCCH resource, either when performing NACK-only feedback using PUCCH format 0 (PF 0), when transmitting one bit, or when multiplexing multiple bits.

Specifically, the UE 200 may operate in accordance with any of the operation examples 1-1 to 1-3.
(Operation example 1-1): Always use m_CS (which means m_{CS}, hereinafter the same)=X.

a_X illustrated in FIG. 7 may be defined by m_0+m_CS. X may be defined by the 3GPP specification, and may be X=0. Further, it may be limited to the case where it is not multiplexed with a Positive SR of one bit.
(Operation example 1-2): Assume that no multiplexing is performed with a Positive SR of one bit (no overlap in at least one of the time domain and frequency domain).
(Operation example 1-3): When multiplexed with a Positive SR of one bit, m_CS=Y is used.

Y may be defined by the 3GPP specification, and may be Y=1. Y may be different (orthogonal) for each user (UE 200), or may be configured in advance.

According to this operation example, information of multiple bits of NACK-only feedback can be transmitted using PUCCH format 0 (PF 0).

### (3.2) Operation Example 2

In this operation example, in Scheme A described above, only BPSK (whose signal point corresponds to a NACK) may be used per one PUCCH resource, either when performing NACK-only feedback using PUCCH format 1 (PF 1), when transmitting one bit, and when multiplexing multiple bits.

In other words, in this operation example, QPSK need not be used. The signal point (see FIG. 7) may be a signal point on the IQ plane corresponding to a NACK of BPSK, but the present disclosure is not limited to such a signal point. For example, a signal point of π/2-BPSK may be used. The PF 1 may be called a long format, in which the number of symbols may be 4 to 14.

Specifically, the UE 200 may operate in accordance with the operation example 2-1 or 2-2.
(Operation example 2-1): Assume that no multiplexing is performed with a Positive SR of one bit.
(Operation example 2-2): When multiplexed with a Positive SR of one bit, a NACK is transmitted by an SR resource.
(Operation example 2-2a): Operate as ACK/NACK feedback instead of NACK-only feedback.
(Operation example 2-2b): Different signal points are used by transmitting Positive SR+NACK and transmitting only Positive SR (in other words, the PDSCH was successfully decoded).

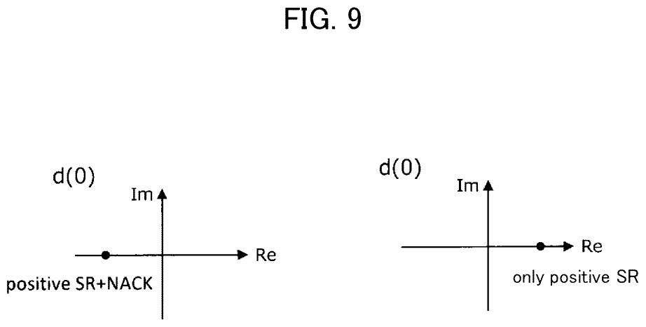

FIG. 9 illustrates an example of a signal point of BPSK according to Example 2-2b. As illustrated in FIG. 9, “−1” may be used in the case of Positive SR+NACK, and “+1” may be used in the case of only Positive SR.

According to this operation example, multiple bits of NACK-only feedback can be transmitted using PUCCH format 1 (PF 1).

### (3.3) Operation Example 3

In this operation example, in Scheme A, each PUCCH resource index may be associated with a table/list (multiple resources) with which HARQ-ACK bits and PUCCH resources are linked. The HARQ feedback method in each PUCCH resource may be operation examples 1, 2, and 5.

Specifically, the UE 200 may operate in accordance with any of the operation examples 3-1 to 3-6.
(Operation example 3-1): One PUCCH resource set (that is, a specific PUCCH resource set) is defined as a set that can be multiplexed up to a maximum of N bits (the number of bits including ACK), and the corresponding table includes a maximum of (2\hat{ }N−1) PUCCH resources.

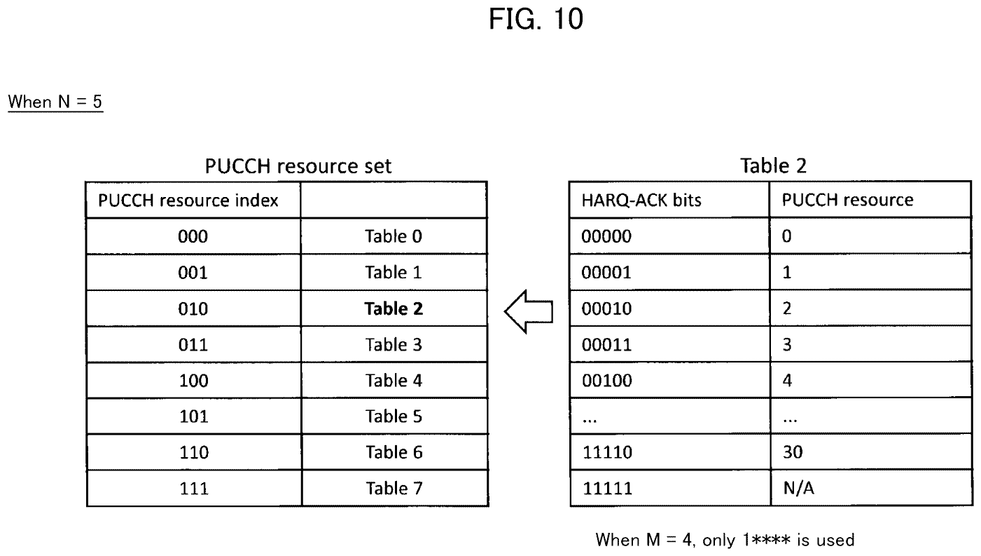

FIG. 10 illustrates a configuration example of a PUCCH resource set according to the operation example 3-1 and of a table linked with the PUCCH resource set.

The PUCCH resource index may be specified, for example, by DCI. FIG. 10 illustrates an example when N=5. As illustrated in FIG. 10, when PUCCH resource index=010, Table 2 may be linked. In Table 2, HARQ-ACK bits of 5 bits and the PUCCH resource may be associated with each other (see FIG. 6).

When N bits can be transmitted and “M<N bits” are multiplexed, the higher or lower (N−M) bits of the HARQ-ACK bit sequence corresponding to each PUCCH resource may be “1”, that is, not a NACK (ACK equivalent). For example, when M=4, only the bit sequence of 1**** may be used.
(Operation example 3-2): Multiple PUCCH resource sets are configured, and each set has a different N.

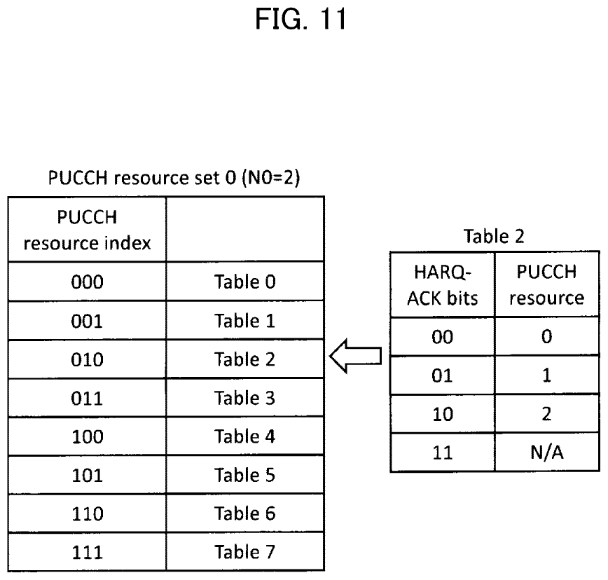

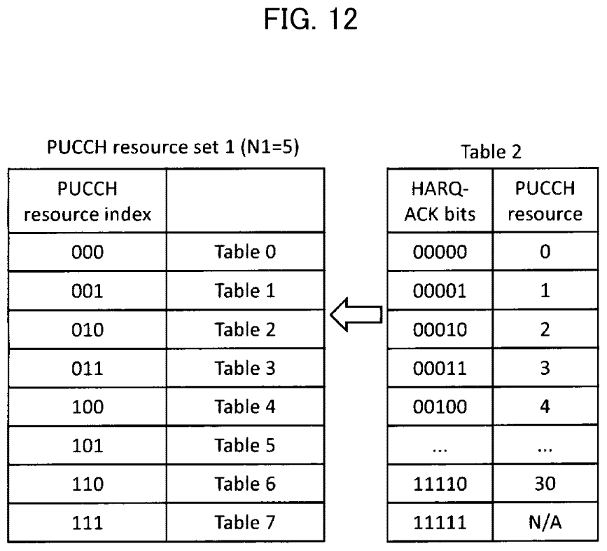

FIG. 11 illustrates a configuration example (part 1) of a PUCCH resource set according to the operation example 3-2 and of a table linked with the PUCCH resource set. FIG. 12 illustrates a configuration example (part 2) of a PUCCH resource set according to the operation example 3-2 and of a table linked with the PUCCH resource set.

For example, four PUCCH resource sets: set 0, 1, 2, and 3 may be configured, each of which can be multiplexed up to a maximum of N0, N1, N2, and N3 bits.

Further, when transmitting the HARQ-ACK bits of M bits (the bits including an ACK), the set to be used may be determined based on the relationship between M and N0, N1, N2, and N3. For example, it may be determined as follows:
set 0 when M<=N0,
set 1 when N0<M<=N1,
set 2 when N1<M<=N2, and
set 3 when N2<M<=N3

N0, N1, N2, and N3 may be different from the values in the case of ACK/NACK feedback, or may be configured in advance. FIGS. 11 and 12 illustrate an example of N0=2 and N1=5. The PUCCH resource determination method in each PUCCH resource set may be performed in accordance with the operation example 3-1.
(Operation example 3-3): Only a single PUCCH resource set is configured.

For example, the operation example 3-1 may be applied regardless of the number of HARQ-ACK bits (including an ACK).
(Operation example 3-4): The UE 200 determines and transmits one PUCCH resource from among the PUCCH resources, which are included in the table/list specified by the PUCCH resource indicator, of the PUCCH resource set to be used, based on the success or failure of PDSCH decoding, or does not transmit an HARQ-ACK when all PDSCHs have been successfully decoded.

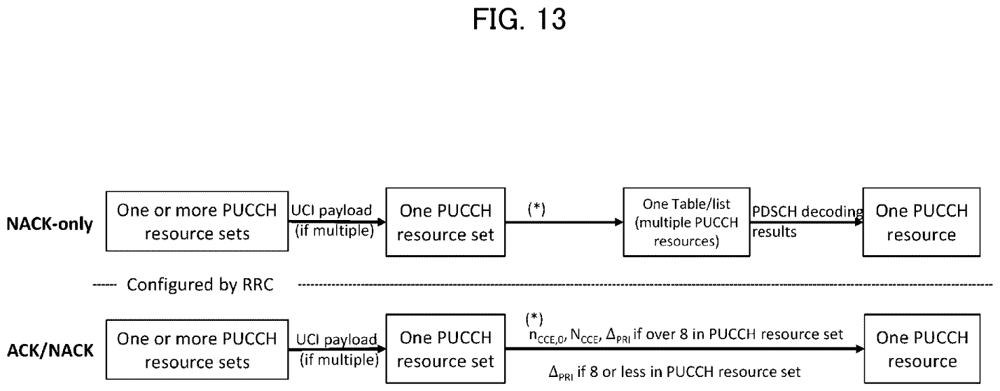

FIG. 13 illustrates a determination example of NACK-only feedback according to the operation example 3-4 and of a PUCCH resource set according to ACK/NACK feedback. The operation example 3-4 may be combined with other examples.

The PUCCH resource set in this operation example may be a set for NACK-only feedback, and may be common to a set for ACK/NACK feedback. FIGS. 10 to 13 may be interpreted as an example in which a set for NACK-only feedback is configured separately from a set for ACK/NACK feedback.
(Operation example 3-5): For the part that can be recognized that PDCCH/PDSCH have not been received by Downlink Assignment Index (DAI), bits are generated as a NACK even in multiplexing of NACK-only feedback.
(Operation example 3-6): In the case where the number of multiplexed bits (may be replaced by the number of bits including an ACK, and the number corresponding to the PDSCH reception) exceed the maximum number of bits in the PUCCH resource set that is configured in accordance with the operation examples 3-1 and 3-2, the UE 200 may operate in accordance with either one of the following options:
(i): The UE 200 does not assume the case.
(ii): The UE 200 drops at least part of (some) bits.

For example, the UE 200 may drop the bits with low priority, or the bits corresponding to the PDSCH scheduled forward/backward in terms of time, or may drop up to the maximum number of bits.
(iii): The UE 200 bundles at least part of (some) bits.

For example, the UE 200 may bundle the bits with low priority, or the bits corresponding to the PDSCH scheduled forward/backward in terms of time, or may bundle up to the maximum number of bits.
(iv): The UE 200 changes feedback by means of the NACK-only feedback scheme to feedback by means of the ACK/NACK feedback scheme, performs to multiplex bits, and transmits the bits to the gNB 100.

For example, when the PUCCH resource (UE-specific PUCCH resource) of the ACK/NACK feedback is configured, the UE 200 may perform to multiplex and transmit the ACK/NACK feedback based on the UE-specific PUCCH resource. Meanwhile, when the PUCCH resource (UE-specific PUCCH resource) of the ACK/NACK feedback is not configured, the UE 200 may not transmit the HARQ feedback. The PUCCH resource of the ACK/NACK feedback used for transmitting the ACK/NACK feedback may be the PUCCH resource indicated by the last DCI on the time axis among the DCI corresponding to the ACK/NACK feedback, or may be the PUCCH resource indicated by the DCI with the highest or lowest frequency index on the frequency axis.
(v): When UE Capability is introduced to define whether to support Scheme A, or when UE Capability is introduced to define whether the UE 200 supports each of the options (ii) to (iv) described above, or when UE Capability is introduced to define whether to support a switching operation between Scheme A and any of the options (ii) to (iv), the UE 200 reports the UE Capability to the network.

In such a case, the UE 200 may perform operation X described below according to the UE Capability. Note that the operation X may mean any of the options (ii) to (iv).

First, the UE 200 that supports Scheme A and supports the operation X may apply the operation X when the number of multiplexed bits exceed the maximum number of bits.

Second, the UE 200 that does not support Scheme A may drop all bits of NACK-only feedback (NACK-only bits) without assuming a case where the number of multiplexed bits exceed the maximum number of bits (that is, option (i)). The UE 200 that does not support the operation X may drop all bits of NACK-only feedback (NACK-only bits) without assuming a case where the number of multiplexed bits exceed the maximum number of bits (that is, option (i)).

Third, the UE 200 that supports a switching operation between Scheme A and the operation X may apply the operation X when the number of multiplexed bits exceed the maximum number of bits.

Fourth, the UE 200 that does not support a switching operation between Scheme A and the operation X may drop all bits of NACK-only feedback (NACK-only bits) without assuming a case where the number of multiplexed bits exceed the maximum number of bits (that is, option (i)).

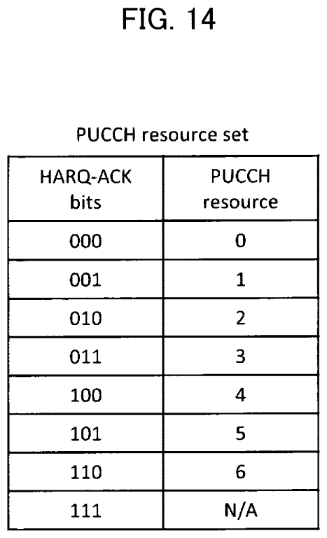

FIG. 14 illustrates an example of a PUCCH resource set according to the operation example 3-6. In this operation example, one PUCCH resource set may be defined as one table/list as illustrated in FIG. 14 and may be configured in which the PUCCH resource is determined by the HARQ-ACK bits without depending on the PUCCH resource indicator.

According to this operation example, the configuration can be realized based on the configuration of existing parameters relating to the configuration of the PUCCH resources, thereby simplifying signaling.

According to this operation example, when Scheme A is executed, a common PUCCH resource can be used among a plurality of UEs 200. When the option (ii) or (iii) is executed, an increase in the PUCCH resource used for multiplexing NACK-only bits can be suppressed. When the option (iv) is executed, a multiplexing operation relating to the existing HARQ-ACK feedback can be applied as it is.
(Operation example 3-7): The maximum number of bits that can be multiplexed with NACK-only bits using Scheme A (“N” described above) may be configured by an upper layer parameter.

Here, the upper layer parameter may be read as meaning an RRC parameter or as meaning RRC signaling. The following options may be considered as options for the upper layer parameter.

In option 1, the maximum number of bits may be implicitly configured by configuring a PUCCH resource. The PUCCH resource may be configured by a correspondence relationship indicated by the PUCCH resource index. That is, the maximum number of bits may be considered to be the number of HARQ-ACK bits associated with each PUCCH resource in Table 2 illustrated in FIGS. 10 to 12. For example, in the examples illustrated in FIGS. 10 and 12, the maximum number of bits may be 5 bits, and in the example illustrated in FIG. 11, the maximum number of bits may be 2 bits. In other words, when the table includes the maximum of (2\hat{ }X−1) PUCCH resources, the maximum number of bits (“N” described above) may be represented by N=X.

In option 2, the maximum number of bits may be explicitly configured by a specific upper layer parameter for configuring the maximum number of bits. The specific upper layer parameter may be considered to be a dedicated parameter for configuring the maximum number of HARQ-ACK bits (“N” described above). The specific upper layer parameter is a newly introduced parameter, and may be different from the parameter for configuring the PUCCH resource.

In option 3, in the option 1 or option 2 described above, the minimum value of candidates for the maximum number of HARQ-ACK bits (“N” described above) may be “0” or “1”. In option 3, when “0” or “1” is configured as N, it may be considered that multiplexing of NACK-only feedback using Scheme A is not performed.

In option 4, in the option 1 or option 2 described above, the minimum value of candidates for the maximum number of HARQ-ACK bits (“N” described above) may be “2”. Here, when a value of “2” or greater is configured as N, it may be considered that multiplexing of NACK-only feedback using Scheme A is performed.

In option 5, in the option 1 or option 2 described above, the maximum value of candidates for the maximum number of HARQ-ACK bits (“N” described above) may be “3”, “4”, or “5”. When “3”, “4”, or “5” is configured as N, it may be considered that multiplexing of NACK-only feedback using Scheme A is performed. Here, by configuring a limit such as “3”, “4”, or “5” on the maximum value candidate for N, it is possible to suppress an increase in the number of PUCCH resources used in multiplexing of NACK-only feedback using Scheme A.

According to the operation example 3-7 described above, it is assumed that the number of PUCCH resources increase exponentially when N increases in Scheme A; however, by adopting a configuration in which the maximum number of HARQ-ACK bits is configured by an upper-layer parameter, it is possible to suppress the number of PUCCH resources used in multiplexing of NACK-only feedback using Scheme A within an acceptable range.
(Operation example 3-8): When the number of multiplexed bits (which may be replaced by the number of bits including an ACK, and the number corresponding to the PDSCH reception) exceed the maximum number configured in operation example 3-7, the operation example 3-6 described above (that is, any of the options (i) through (v)) may be performed.

### (3.4) Operation Example 4

In this operation example, only one PUCCH resource set for NACK-only feedback may be configured in Scheme C.

Specifically, the UE 200 may operate in accordance with any of the operation examples 4-1 to 4-4.
(Operation example 4-1): Only PUCCH format 0 (PF 0) or PUCCH format 1 (PF 1) is associated.
(Operation example 4-2): Even when the HARQ-ACK bits for multiple PDCCH/PDSCH receptions are bundled, the number of HARQ-ACK bits to be transmitted is one bit, and the PUCCH resource set is used.
(Operation example 4-3): For the part that can be recognized that PDCCH/PDSCH have not been received by DAI, bundling is performed as a NACK (that is, PDCCH/PDSCH decoding have failed).
(Operation example 4-4): It is not assumed that bundling of HARQ-ACK is performed for PDCCH/PDSCH reception exceeding a predetermined number.

According to this operation example, multiple bits of NACK-only feedback can be bundled and transmitted together, thereby simplifying the configuration of the PUCCH resources.

### (3.5) Operation Example 5

In this operation example, when multiple bits are multiplexed for NACK-only feedback using PUCCH format 0 (PF 0), a plurality of cyclic shift indexes may be used per one PUCCH resource.

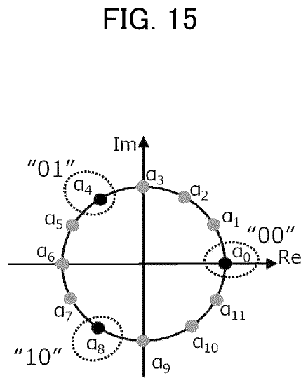

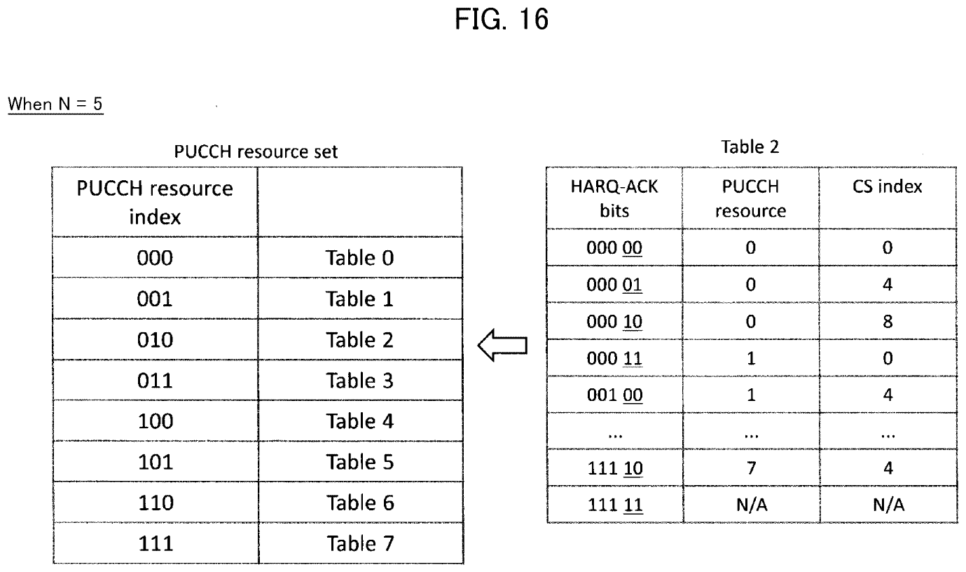

Specifically, the UE 200 may operate in accordance with operation example 5-1 or 5-2.
(Operation example 5-1): A plurality of cyclic shift indexes are linked with one PUCCH resource, and the success or failure of PDSCH decoding determines which of the cyclic shift indexes is used. FIG. 15 illustrates an example of signal points on an IQ plane according to operation example 5-1. FIG. 16 illustrates a configuration example of a PUCCH resource set according to the operation example 5-1 and of a table linked with the PUCCH resource set.

For example, the cyclic shift indexes 0, 4, 8 may be linked with the PUCCH resource X, and regarding the two HARQ-ACK bits (may be replaced by the number of bits including an ACK, and the number corresponding to the PDSCH reception), the cyclic shift indexes may be used as follows.
HARQ-ACK bits=00: CS index 0
HARQ-ACK bits=01: CS index 4
HARQ-ACK bits=10: CS index 8
HARQ-ACK bits=11: N/A
(Example 5-2): parts (some) of the multiple bits are represented by selecting a cyclic shift index, and the others are represented by the PUCCH resource.

For example, in FIG. 16, the underlined HARQ-ACK bits (2 bits) may be represented by selecting a cyclic shift index, and the others (3 bits) may be represented by the PUCCH resource.

Note that the operation example 5-2 may be combined with the operation example 3.

### (4) Operation and Effect

According to the embodiment described above, the following operation and effect can be obtained. Specifically, in Scheme A, the UE 200 can apply only one cyclic shift index to one resource in the PUCCH (uplink control channel) when feeding back only a NACK of the HARQ.

In addition, in Scheme A, the UE 200 can apply BPSK (only) to one resource of the PUCCH when feeding back only a NACK of the HARQ.

In addition, in Scheme A, the UE 200 can assume that an index of the PUCCH resource indicates a correspondence relationship between a bit string of the HARQ feedback and the PUCCH resource when feeding back only a NACK of the HARQ.

In addition, in Scheme C, the UE 200 can assume that there is only one set of PUCCH resources when feeding back only an ACK.

In addition, the UE 200 can apply a plurality of cyclic shift indexes to one resource of the PUCCH when multiplexing multiple bits in the NACK-only feedback using a specific PUCCH format (PF 0).

Thus, the method of NACK-only feedback of each UE 200 can be recognized in the network, thereby realizing efficient NACK-only feedback in MBS while avoiding blind decoding or the like.

### (5) Other Embodiments

Although the embodiment has been described as above, the present disclosure is not limited to the description of the embodiment, and it is obvious to those skilled in the art that various modifications and improvements are possible.

For example, in the embodiment described above, the names PDCCH and PDSCH are used as downlink channels; however, different names may be used as long as they are downlink control channels or downlink data channels (which may be shared channels).

In the above description, configure, activate, update, indicate, enable, specify, and select may be interchangeably interpreted. Similarly, link, associate, correspond, and map may be interchangeably interpreted, and allocate, assign, monitor, and map may also be interchangeably interpreted.

In addition, specific, dedicated, UE-specific, and UE-dedicated may be interchangeably interpreted. Similarly, common, shared, group-common, UE-common, and UE-shared may be interchangeably interpreted.

The block diagram (FIG. 4) used in the description of the above-described embodiment illustrates blocks in units of functions. Those functional blocks (components) can be realized by any combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

Further, the above-described gNB 100 and UE 200 (the device) may function as a computer that performs processing of a radio communication method of the present disclosure. FIG. 17 is a diagram illustrating an example of a hardware configuration of the device. As illustrated in FIG. 17, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIG. 4) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a central processing unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above may be executed by one processor 1001 or may be executed simultaneously or sequentially by two or more processors 1001. The processor 1001 may be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 may be referred to as an auxiliary storage device. The recording medium may be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI)), higher layer signaling (for example, RRC signaling, Medium Access Control (MAC) signaling, broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure may be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information may be stored in a specific location (for example, a memory) or may be managed in a management table. The information to be input/output can be overwritten, updated, or added. The information may be deleted after outputting. The inputted information may be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present disclosure may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or any combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure may be represented by an absolute value, may be represented by a relative value from a predetermined value, or may be represented by corresponding other information. For example, a radio resource may be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be read as meaning a mobile station (user terminal, hereinafter, the same). For example, each aspect/embodiment of the present disclosure may be applied to a configuration in which communication between a base station and a mobile station is replaced with communication between a plurality of mobile stations (which may be called Device-to-Device (D2D), Vehicle-to-Everything (V2X), or the like). In this case, the mobile station may have the function of a base station. In addition, words such as “uplink” and “downlink” may also be read as meaning words corresponding to inter-terminal communication (for example, “side”). For example, an uplink channel, a downlink channel, or the like may be read as meaning a side channel (or a side link).

Similarly, the mobile station in the present disclosure may be read as meaning a base station. In this case, the base station may have the function of the mobile station. A radio frame may be composed of one or more frames in the time domain. Each of the one or more frames in the time domain may be referred to as a subframe. A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1 to 13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-coded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as meaning a TTI having a time length exceeding 1 ms, and a short TTI (for example, shortened TTI) may be read as meaning a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a Physical Resource Block (PRB), a Sub-Carrier Group (SCG), a Resource Element Group (REG), a PRB pair, a RB pair, and the like.

A resource block may be configured by one or more Resource Elements (REs). For example, one RE may be a radio resource domain of one subcarrier and one symbol.

A Bandwidth Part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be configured in one carrier for the UE.

At least one of the configured BWPs may be active, and the UE does not have to expect to transmit and receive predetermined signals/channels outside the active BWP. Note that “cell”, “carrier”, and the like in this disclosure may be read as meaning “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the Cyclic Prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be read as meaning “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A Reference Signal may be abbreviated as RS and may be called a Pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element has to precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as meaning “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

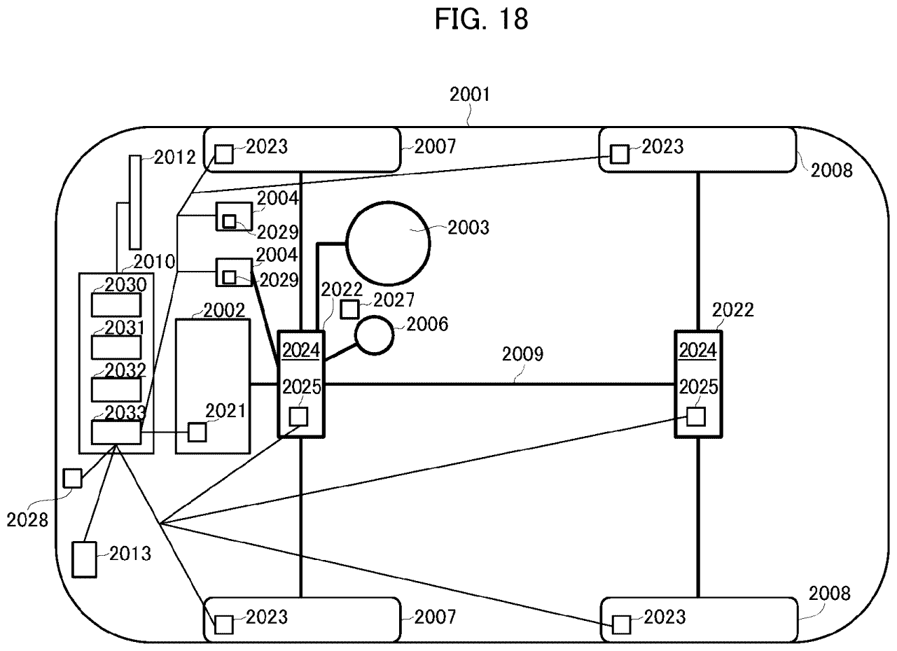

FIG. 18 shows a configuration example of a vehicle 2001. As shown in FIG. 18, the vehicle 2001 includes a drive 2002, a steering 2003, an accelerator pedal 2004, a brake pedal 2005, a shift lever 2006, left and right front wheels 2007, left and right rear wheels 2008, an axle 2009, an electronic controller 2010, various sensors 2021 to 2029, an information service unit 2012, and a communication module 2013.

Examples of the drive 2002 include, an engine, a motor, and a hybrid of an engine and a motor.

The steering 2003 includes at least a steering wheel (also called a handle) and steers at least one of the front and rear wheels based on an operation of a steering wheel operated by a user.

The electronic controller 2010 includes a microprocessor 2031, a memory (ROM, RAM) 2032, and a communication port (IO port) 2033. The electronic controller 2010 receives signals from various sensors 2021 to 2027 provided in the vehicle. The electronic controller 2010 may be called an ECU (Electronic Control Unit).

The signals from the various sensors 2021 to 2028 include a current signal from a current sensor 2021 for sensing current of a motor, a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like.

The information service unit 2012 includes various devices such as a car navigation system, an audio system, a speaker, a television, and a radio for providing various information such as driving information, traffic information, and entertainment information, and one or more ECUs for controlling these devices. The information service unit 2012 provides various multimedia information and multimedia services to an occupant of the vehicle 1 by using information acquired from an external device through a communication module 2013 and the like.

A driver support system unit 2030 comprises various devices such as a millimeter wave radar, a Light Detection and Ranging (LiDAR), a camera, a positioning locator (for example, GNSS), map information (for example, high-definition (HD) maps, autonomous vehicle (AV) maps, and the like), a gyroscopic system (for example, an Inertial Measurement Unit (IMU), an Inertial Navigation System (INS), and the like), an Artificial Intelligence (AI) chip, and an AI processor for providing functions to prevent accidents or reduce a driving load of a driver, and one or more ECUs for controlling these devices. Further, the driver support system unit 2030 transmits and receives various kinds of information through the communication module 2013 to realize a driver support function or an automatic driving function.

The communication module 2013 can communicate with the microprocessor 2031 and components of the vehicle 1 through a communication port. For example, the communication module 2013 transmits and receives data through the communication port 2033 to and from the drive 2002, steering 2003, accelerator pedal 2004, brake pedal 2005, shift lever 2006, left and right front wheels 2007, left and right rear wheels 2008, axle 2009, microprocessor 2031 in the electronic control 2010, memory (ROM, RAM) 2032, and sensor 2021 to 2028.

The communication module 2013 is a communication device that can be controlled by the microprocessor 2031 of the electronic controller 2010 and can communicate with an external device. For example, The communication module 2013 transmits and receives various kinds of information via radio communication with the external device. The communication module 2013 may be placed inside or outside the electronic control unit 2010. Examples of the external device may include a base station, a mobile station, and the like.

The communication module 2013 transmits a current signal coming from a current sensor and input to the electronic controller 2010 to an external device via radio communication. Further, the communication module 2013 transmits a rotation speed signal of a front wheel and a rear wheel acquired by the speed sensor 2022, a pressure signal of a front wheel and a rear wheel acquired by an air pressure sensor 2023, a speed signal of a vehicle acquired by a speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic controller 2010 to an external device via radio communication.

The communication module 2013 receives various information (traffic information, signal information, inter-vehicle information, and the like.) transmitted from the external device and displays on the information service unit 2012 provided in the vehicle. Further, the communication module 2013 stores various information received from the external device in a memory 2032 usable by the microprocessor 2031. Based on the information stored in the memory 2032, the microprocessor 2031 may control the drive 2002, the steering 2003, the accelerator pedal 2004, the brake pedal 2005, the shift lever 2006, the left and right front wheels 2007, the left and right rear wheels 2008, the axle 2009, the sensors 2021 to 2028, and the like. provided in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input Device
1006 Output device
1007 Bus
2001 Vehicle
2002 Drive
2003 Steering
2004 Axel pedal
2005 Brake pedal
2006 Shift lever
2007 Left and right front wheels
2008 Left and right rear wheels
2009 Axle
2010 Electronic controller
2012 Information service unit
2013 Communication module
2021 Current sensor
2022 Speed sensor
2023 Air pressure sensor
2024 Vehicle speed sensor
2025 Acceleration sensor
2026 Brake pedal sensor
2027 Shift lever sensor
2028 Object detection sensor
2029 Axel pedal sensor
2030 Operation support system
2031 Microprocessor
2032 Memory (ROM, RAM)
2033 Communication port

1. A terminal comprising:
a transmission unit that transmits feedback of an automatic repeat request; and
a control unit assuming that when a bit string of the feedback and a resource of an uplink control channel are associated with each other and only a negative acknowledgment is fed back, an index of the resource indicates a correspondence relationship between a bit string of the feedback and the resource,
wherein an upper limit on the number of multiplexed bits of the feedback is configured by an upper layer parameter.

2. The terminal according to claim 1,
wherein an upper limit on the number of multiplexed bits of the feedback is implicitly configured by a configuration of the resource.

3. The terminal according to claim 1,
wherein an upper limit on the number of multiplexed bits of the feedback is explicitly configured by a specific upper layer parameter for configuring an upper limit on the number of multiplexed bits of the feedback.

4. A base station comprising:
a reception unit that receives feedback of an automatic repeat request; and
a control unit assuming that when a bit string of the feedback and a resource of an uplink control channel are associated with each other and only a negative acknowledgment is fed back, an index of the resource indicates a correspondence relationship between a bit string of the feedback and the resource,
wherein an upper limit on the number of multiplexed bits of the feedback is configured by an upper layer parameter.

5. A radio communication system including a terminal and a base station, wherein
the terminal comprises:
a transmission unit that transmits feedback of an automatic repeat request; and
a control unit assuming that when a bit string of the feedback and a resource of an uplink control channel are associated with each and only a negative acknowledgment is fed back, an index of the resource indicates a correspondence relationship between a bit string of the feedback and the resource, and
an upper limit on the number of multiplexed bits of the feedback is configured by an upper layer parameter.

6. A radio communication method comprising:
a step of transmitting feedback of an automatic repeat request; and
a step of assuming that when a bit string of the feedback and a resource of an uplink control channel are associated with each other and only a negative acknowledgment is fed back, an index of the resource indicates a correspondence relationship between a bit string of the feedback and the resource,
wherein an upper limit on the number of multiplexed bits of the feedback is configured by an upper layer parameter.
